(19) United States
(12) Patent Application Publication
(10) Pub. No.: US 2014/0185772 A1
(43) Pub. Date: Jul. 3, 2014

(54) HUMAN BODY INSPECTION SYSTEM

(71) Applicant: Nuctech Company Limted, Beijing (CN)

(72) Inventors: Zhiqiang CHEN, Beijing (CN); Yuanjing LI, Beijing (CN); Ziran ZHAO, Beijing (CN); Wanlong WU, Beijing (CN); Le TANG, Beijing (CN); Yinong LIU, Beijing (CN); Yingkang JIN, Beijing (CN); Wenguo LIU, Beijing (CN); Shuo CAO, Beijing (CN); Zhimin ZHENG, Beijing (CN); Guangwei DING, Beijing (CN); Wentao YU, Beijing (CN); Yi ZHOU, Beijing (CN)

(21) Appl. No.: 14/135,989

(22) Filed: Dec. 20, 2013

(30) Foreign Application Priority Data
Dec. 27, 2012 (CN) 201210581699.6

(51) Int. Cl. G01V 5/00

(52) U.S. Cl. CPC G01V 5/0025
USPC 378/87

(57) ABSTRACT

The invention discloses a human body inspection system comprising: an X-rays source for emitting X-rays to a human body to be inspected; a modulation and collimation device for modulating and collimating the X-rays from the X-rays source; a detector that receives X-rays scattered from the human body to be inspected; a guiding rail forming an enclosed detection region, wherein the human body to be inspected is in the detection region, and the X-rays source, the modulation and collimation device and the detector are positioned in a same side relative to the human body, and the X-rays source, the modulation and collimation device and the detector together move along the guiding rail in whole so that the X-rays can scan all over the human body.

This application claims benefit of Serial No. 201210581699.6, filed 27 Dec. 2012 in China and which application is incorporated herein by reference. To the extent appropriate, a claim of priority is made to each of the above disclosed applications.

### FIELD OF THE INVENTION

The present invention relates to nuclear technology imaging application, and particularly relates to a back-scattering imaging.

### DESCRIPTION OF THE RELATED ART

In the back-scattering detection imaging application, a ray is modulated and collimated into a pencil beam, and the pencil beam scans an object in the means of point-by-point, while a detector receives a ray scattered back from the object, such that a back-scattering image reflecting the information of the object can be obtained by point-by-point corresponding of scanning positions with signals during the data processing. For example, Chinese patent document publication No.CN102116747A discloses a scanning device for back-scattering imaging.

The known scanning pattern in the prior inspection system is as follows: a pencil beam ray is modulated and collimated in the first dimension direction; a pencil beam ray plane translates together with a detector opposite to a human body along a second dimension direction; the first dimension direction is generally transverse to the second dimension direction.

Typically, there are two ways of scanning in the prior art: one of which is that a pencil beam ray is in the horizontal direction and the pencil beam ray plane translates in a vertical direction; another one is that a pencil beam ray is in a vertical direction and a pencil beam ray plane translates in a horizontal direction.

The disadvantage of the scanning pattern is that only an image of a side of the body closer to the detector can be detected by inspection personnel per scanning, and the other side of the body is a blind area which is unable to be scanned. In order to eliminate the blind area and obtain a complete body image of the human body, the passenger to, be inspected need to turn 180° after a scan and then to be scanned the second time, that is, two scannings are required. The turning movement will increase the invalid detection time and reduce the overall detection passing rate. For example, scanning time for single side is typically about 10 seconds, and total amount of time spent by notifying the passenger to be inspected by the operator that he/she may turn and time spent by actually turning and re-posing of the passenger to be inspected is typically 1.5 to 2 seconds. Additionally, 0.5 to 1 second or so is need for the operator to recognize that the passenger to be inspected is re-posed. Generally, such invalid detection time amount up to 20-30% of the total time spent for carrying out the whole scanning process; more invalid time will be taken if the passenger to be inspected acts or slowly or the communication between the passenger to be inspected and the operator is slow.

Another disadvantage of this scanning pattern is that even if twice scanning detection are performed, since a scanning beam surface and the detector are moved linearly such that a surface which is parallel to the scanning beam surface always exists on the human body, which cannot be clearly and completely scanned. That is, there is still a small portion of the blind area for scanning, such as both sides of the chest, left and right sides of legs and other parts of the human body.

### SUMMARY OF THE INVENTION

To resolve the above technical problem, the present invention provides a human body inspection system for scanning the body quickly without any scan blind area.

The inspection system according to the present invention comprises: an X-rays source for emitting X-rays to a human body to be inspected; a modulation and collimation device for modulating and collimating the X-rays from the X-rays source into pencil beam rays moving uniformly along a vertical direction; a detector that receives X-rays scattered from the human body to be inspected, a guiding rail forming an enclosed detection region, wherein the human body to be inspected is in the detection region, and the X-rays source, the modulation and collimation device and the detector are positioned in a same side relative to the human body, and the X-rays source, the modulation and collimation device and the detector together move along the guiding rail so that the X-rays can scan all over the human body.

Preferably, the shape of the guiding rail is a circle or an ellipse.

Preferably, the system further comprises a controlling member for controlling the X-rays source and the modulation and collimation device so that the human body is scanned by the X-rays according to the predetermined ways.

Preferably, the X-rays source, the modulation and collimation device and the detector are fixed by a detachable fixing device.

Preferably, the detachable fixing device is a connecting rod and a screw.

According to the human body inspection system, the common scanning blind area, such as both sides of the body, arms and legs, etc., can be completely eliminated.

Additionally, when a passenger is examined by the human body inspection system according to the present invention, as the passenger to be inspected is not required to turn around and change his posture, which can minimize the invalid time of the entire inspection, improve the passing rate of passenger to be inspected. Furthermore, feelings of the passenger to be inspected of being controlled caused by changing posture can also be greatly improved, reducing their psychological discomfort and resentment.

Hereinafter, the preferable embodiments of the present invention is further described in detail through the accompanying drawings, and the above purpose, other purpose, character and advantage are more obvious.

### BRIEF DESCRIPTION OF THE DRAWINGS

FIG. 1 is a schematic view of an embodiment of the human body inspection system according to the invention.

### DETAILED DESCRIPTION OF THE EMBODIMENTS

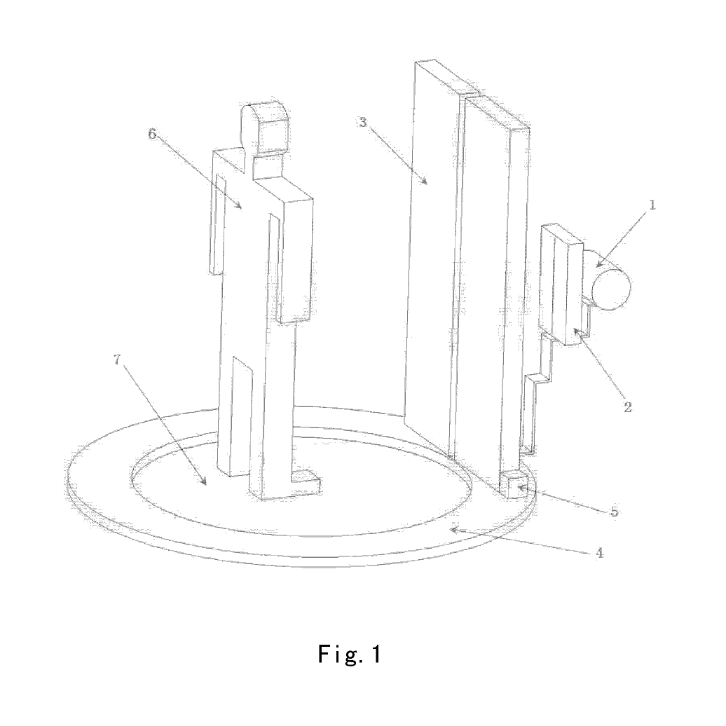

As shown in FIG. 1, the human body inspection system according to the present invention comprises: an X-rays source 1 for emitting X-rays to a human body to be inspected; a modulation and collimation device 2 for modulating and collimating the X-rays from the X-rays source 1 into pencil beam rays; a detector 3 that receives X rays scattered from the human body to be inspected, a guiding rail 4 forming an enclosed detection region 7, wherein the human body 6 to be inspected is in the detection region 7, and the X-rays source 1, the modulation and collimation device 2 and the detector 3 are positioned in a same side relative to the human body 6, and the X-rays source 1, the modulation and collimation device 2 and the detector 3 together move along the guiding rail so that the X-rays can scan the all over the human body 6 and exit opening of the X-rays source is always directed to the human body, while exit opening of the X-rays source is always directed to the human body.

In a preferable embodiment according to the present invention, the shape of the guiding rail 4 is a circle or an ellipse

In a preferable embodiment according to the present invention, the system further comprises a controlling member 5 for controlling the X-rays source 1 and the modulation and collimation device 2 so that the human body is scanned by the X-rays according to the predetermined ways.

In a preferable embodiment according to the present invention, the X-rays source 1, the modulation and collimation device 2 and the detector 3 are fixed by detachable fixing device.

In a preferable embodiment according to the present invention, the detachable fixing device is a connecting rod and a screw.

In the specific embodiment, the X-rays source 1 may be an X-rays generator based on the electron shooting target or may be radioactive isotope. Preferably, the source 1 is an X-rays generator. It should be noted it is obvious for those skilled in the art to adopt other suitable X-rays generators.

The rays from the X-rays source 1 is modulated and collimated by the modulation and collimation device 2 to form pencil beam rays moving uniformly along a vertical direction. The detector 3 may absorb X-rays and convert it into electrical signals, then the electrical signals are converted into digital signals to be displayed by computer.

As the X-rays source 1, the modulation and collimation device 2 and the detector 3 are fixed by a connecting rod and a screw. During moving, the relative position among the X-rays source 1, the modulation and collimation device 2 and the detector 3 is retained, and exit opening of the X-rays source 1 is always directed to the human body.

As shown in FIG. 1, the guiding rail 4 provides a path along which the X-rays source 1, the modulation and collimation device 2 and the detector 3 move in the horizontal direction. According to a preferred embodiment of the present invention, the shape of the guiding rail 4 is configured to be a circle or an ellipse, and preferably to be a circle. The guiding rail 4 is a closed ring or one part of a closed ring, and preferably is a closed ring. The operation of the modulation and collimation device 2 is controlled by the controlling member 5, and the controlling member 5 also controls the movement of the X-rays source 1, the modulation and collimation device 2 and the detector 3 moving along the guiding rail 4 together.

A human body inspection system according to the present invention performs security detection to a passenger as follows:

A passenger 6 to be inspected enters a detection region land stands still. A controlling member 4 controls the operation of the modulation and collimation device 2 so that the X-rays for scanning the human body is formed into pencil beam rays and the pencil beam rays scan the human body uniformly along a vertical direction; then, the controlling member 4 controls the X-rays source 1, the modulation and collimation device 2 and the detector 3 to move along the arc guiding rail 4 in whole; the controlling member 5 controls the detector 3 to perform signal acquisition in accordance with the corresponding frequency of the modulation and collimation device 2; at last, when the X-rays source 1, the modulation and collimation device 2 and the detector 3 move from the starting point to end of the guide rail, the scanning of the human body is finished, and the passenger to be inspected leaves the detection region 7 without turning around or changing his posture.

The above embodiments do not intend to limit the present invention, and those having ordinary skill will understand that the present invention can make changes to these embodiments without departing from the spirit and the principles in the general concept of the present invention. The scope of the present invention is defined by the claims and their equivalents. For example, the control device can also be integrated with the external monitoring control system, and the system can be further simplified.

With the human body inspection system according to the present invention, the common scanning blind area can be completely eliminated; and as a passenger to be inspected is not required to turn around and change his posture during the scanning, the time for implementing the inspection is greatly reduced.

What is claimed is:

1. A human body inspection system, comprising:
an X-rays source for emitting X-rays to a human body to be inspected;
a modulation and collimation device for modulating and collimating the X-rays from the X-rays source;
a detector that receives X-rays scattered from the human body to be inspected;
a guiding rail forming an enclosed detection region, wherein the human body to be inspected is in the detection region, and
the X-rays source, the modulation and collimation device and the detector are positioned in a same side relative to the human body, and the X-rays source, the modulation and collimation device and the detector together move along the guiding rail so that the X-rays scan all over the human body.

2. The human body inspection system according to claim 1, wherein the shape of the guiding rail is a circle or an ellipse.

3. The human body inspection system according to claim 1, wherein the system further comprises a controlling member for controlling the X-rays source and the modulation and collimation device so that the human body is scanned by the X-rays according to the predetermined ways.

4. The human body inspection system according to claim 1, wherein the X-rays source, the modulation and collimation device and the detector are fixed by detachable fixing device.

5. The human body inspection system according to claim 4, wherein the detachable fixing device is a connecting rod and a screw.
